(19) United States
(12) Patent Application Publication
(10) Pub. No.: US 2026/0303413 A1
(43) Pub. Date: Oct. 1, 2026

(54) MAN-PORTABLE PASSIVE DETECTION AND TRACKING SYSTEM

(71) Applicant: Raytheon Company, Arlington, VA (US)

(72) Inventors: Erik M. Baumgarten, McKinney, TX (US); Michael I. Stern, Dallas, TX (US); Jonathan F. Holmes, Roswell, GA (US); John D. Farnum, Parker, TX (US)

(21) Appl. No.: 19/097,644

(22) Filed: Apr. 1, 2025

(51) Int. Cl. H04L 25/02; H04B 10/2575; H04L 5/00

(52) U.S. Cl. CPC H04L 25/0226; H04B 10/25759; H04L 5/0048

(57) ABSTRACT

A system for passive detection of radio frequency (RF) signals includes a plurality of inputs configured to receive a plurality of signals associated with received RF signals. The system also includes a base station configured to receive the plurality of signals, determine cross-correlation delays between pairs of the plurality of signals, and determine a position of a source of the received RF signals based on the determined cross-correlation delays. The system may also include a plurality of receivers configured to receive the RF signals and convert the received RF signals into the plurality of signals for transmission to the base station. The system may further include a plurality of fiber optic tethers configured to connect the plurality of receivers to the base station.

### TECHNICAL FIELD

This disclosure relates generally to passive detection systems. More specifically, this disclosure relates to a man-portable passive detection and tracking system.

### BACKGROUND

Forward-deployed troops and high-value assets are often under threat from asymmetric attacks, including one-way attack drones and gray-zone maritime threats. To protect against these threats, passive location systems can be used to monitor, track, and engage airborne emitters. In a civilian telecom infrastructure, similar capabilities are often provided for emergency services to enable the localization of mobile devices through towers that carry their signals. However, many of these types of systems are ground-based and require the use of tall antennas in order to provide detection capabilities.

### SUMMARY

This disclosure relates to a man-portable passive detection and tracking system.

In some examples, a system for passive detection of radio frequency (RF) signals includes a plurality of inputs configured to receive a plurality of signals associated with received RF signals. The system also includes a base station configured to receive the plurality of signals, determine cross-correlation delays between pairs of the plurality of signals, and determine a position of a source of the received RF signals based on the determined cross-correlation delays.

The system where the base station may include converter circuitry configured to convert the received plurality of signals into recovered RF signals and at least one processor configured to determine the position of the source based on receive delays calculated from a cross-correlation of the recovered RF signals. The base station may include converter circuitry configured to convert the received plurality of signals into recovered RF signals, RF processing circuitry configured to determine the receive delays calculated from cross-correlation of the recovered RF signals and at least one processor configured to determine the position of the source. The system may include a plurality of receivers configured to receive the RF signals and convert the received RF signals into the plurality of signals for transmission to the base station and a plurality of fiber optic tethers configured to connect the plurality of receivers to the base station. The base station is configured to transmit a sounding signal, receive a plurality of RF response signals based on the sounding signal from the plurality of receivers and determine positions of the plurality of receivers based on the plurality of RF response signals. Each drone may include an antenna configured to receive the RF signals and converter circuitry configured to convert between RF signals and optical signals. Receivers are configured to be repeatedly repositioned to alter a coverage area provided by the plurality of receivers. The base station is configured to determine the cross-correlation delays using cross-correlation of time differences of arrival between the pairs of the plurality of signals.

In other examples, a method for passive detection of radio frequency (RF) signals includes receiving a plurality of signals associated with received RF signals from a plurality of receivers at a base station. The method also includes determining cross-correlation delays between the plurality of signals. The method also includes determining a position of a source of the received RF signals based on the determined cross-correlation delays.

The method may include converting the received plurality of signals into recovered RF signals using converter circuitry at the base station and determining the cross-correlation delays and determine the position of the source based on the recovered RF signals using at least one processor at the base station. The method may include converting the received plurality of signals into recovered RF signals using converter circuitry at the base station, determining the cross-correlation delays using RF processing circuitry at the base station and determining the position of the source of the received RF signals based on the determined cross-correction delays using at least one processor at the base station. The method may include receiving the RF signals at the plurality of receivers, converting the received RF signals into the plurality of signals for transmission to the base station and transmitting the plurality of signals over a plurality of fiber optic tethers connecting the plurality of receivers to the base station. The method may include transmitting a sounding signal from the base station to the plurality of drone, receiving a plurality of RF response signals based on the sounding signal from the plurality of receivers at the base station, and determining positions of the plurality of receivers based on the plurality of RF response signals at the base station. The method may include repeatedly repositioning the plurality of receivers to alter a coverage area provided by the plurality of receivers. Determining the cross-correlation delays may include using cross-correlation of time differences of arrival between the pairs of the plurality of signals at the base station.

In still other examples, a system for passive detection of radio frequency (RF) signals includes a plurality of receivers configured to receive the RF signals and convert the received RF signals into a plurality of signals. The system also includes a base station configured to. The system also includes receive the plurality of signals. The system also includes determine cross-correlation delays between pairs of the plurality of signals. The system also includes determine a position of a source of the received RF signals based on the determined cross-correlation delays. The system also includes transmit a sounding signal from the base station. The system also includes receive a plurality of RF response signals based on the sounding signal from the plurality of receivers. The system also includes determine positions of the plurality of receivers based on the plurality of RF response signals. The system also includes a plurality of fiber optic tethers configured to connect the plurality of receivers to the base station.

Any single one or any combination of the following features may be used with the examples above. The system where the base station may include converter circuitry configured to convert between optical signals and RF signals, RF processing circuitry configured to determine the cross-correlation delays, and at least one processor configured to determine the position of the source. The converter circuitry may include a plurality of RF-over-fiber converters, each RF-over-fiber converter of the plurality of RF-over-fiber converters associated with one of the plurality of receivers. Each drone may include an antenna configured to receive the RF signals, and converter circuitry configured to convert between RF signals and optical signals. Receivers are configured to be repeatedly repositioned to alter a coverage area provided by the plurality of receivers.

Other technical features may be readily apparent to one skilled in the art from the following figures, descriptions, and claims.

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates a block diagram of an example man-portable passive location system including a plurality of airborne drones in accordance with this disclosure;

FIG. 2 illustrates a block diagram of example hardware components of a drone and a base station in a system in accordance with this disclosure;

FIG. 3 illustrates a block diagram of example components used for determining an emitter location in accordance with this disclosure;

FIG. 4 illustrates a flow diagram of an example process for determining an emitter location using the components of FIG. 3 in accordance with this disclosure;

FIG. 5 illustrates a block diagram of example components used for determining locations of drones within a drone array in accordance with this disclosure; and

FIG. 6 illustrates a flow diagram of an example process for determining locations of drones within a drone array in accordance with this disclosure.

### DETAILED DESCRIPTION

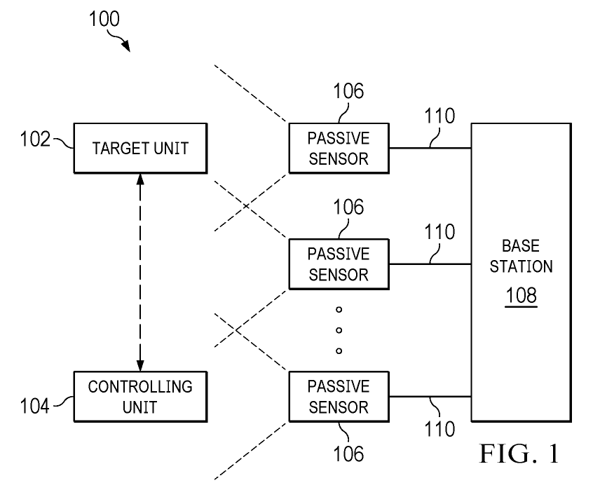

FIGS. 1-6, described below, and the various embodiments used to describe the principles of the present disclosure are by way of illustration only and should not be construed in any way to limit the scope of this disclosure. Those skilled in the art will understand that the principles of the present disclosure may be implemented in any type of suitably arranged device or system.

As noted above, forward-deployed troops and high-value assets are often under threat from asymmetric attacks, including one-way attack drones and gray-zone maritime threats. In order to protect against these threats, passive location systems can be used to monitor, track, and engage airborne emitters. In a civilian telecom infrastructure, similar capabilities are often provided for emergency services to enable the localization of mobile devices through towers that carry their signals. However, many of these types of systems are ground-based and require the use of tall antennas in order to provide detection capabilities. This disclosure provides a man-portable passive detection and tracking system that can overcome these or other types of issues.

FIG. 1 illustrates a block diagram of an example man-portable passive location system 100 including a plurality of airborne drones or other receivers in accordance with this disclosure. Among other things, the system 100 is useful for detecting the position of a target unit 102, such as a one-way attack drone. The system 100 may also detect the presence of a controlling unit 104 that is controlling the target unit 102 via RF signals. The system 100 may be used to detect all types of signals from various transmitting units such as cell phones, handheld radios, maritime radars, airborne radars, etc. As shown in FIG. 1, the system 100 uses a plurality of passive sensors 106 that, in some embodiments, may represent a plurality of airborne drones. While FIG. 1 illustrates three passive sensors 106, it will be appreciated that any number of passive sensors 106 greater than or less than three may be used to form a passive detection array.

Each of the passive sensors 106 is connected to a ground station 108 via a tethered connection 110. It will be appreciated that the ground station 108 does not necessarily need to be located on the ground and may comprise a base station at any location. While some embodiments of this disclosure may utilize optical fibers for the tethered connections 110, other types of tethered connections may be utilized to provide different types of signaling between the ground station 108 and the passive sensors 106. In some embodiments, the passive sensors 106 as implemented using airborne drones can be used to provide a pop-up wideband detection and tracking system that is integrated with RF-over-fiber technology to the ground station 108.

The airborne drones representing the passive sensors 106 may move around in a plurality of differing positions. By implementing the passive sensors 106 in movable drones or other movable technologies, the passive sensors 106 may be periodically, continually, or otherwise moved in order to create diverse detection geometries. This may enable the overcoming of potential weak spots within the coverage and detection area of the detection array provided by the passive sensors 106. Additionally, the ability to move the passive sensors 106 to a variety of different positions may enable rebalancing of the coverage and detection areas of the array on the fly using adaptive formations for the drones. Thus, upon the determination of particular weak spots within the coverage and detection array, the passive sensors 106 may be moved to new locations in order to provide better detection within a known weak area.

The system 100 provides a lightweight and rapidly-scalable sensing solution that may be quickly deployed for ground-based troops, base defenses, or other applications. Among other things, the passive sensors 106 can provide detection capabilities to help offset asymmetric threats of, for example, improvised first-person view (FPV) or other drones. The use of passive sensors allows users of the system 100 to remain passive and undetected, providing little indication to an adversary of surveillance capabilities for detecting the target units 102 and controlling units 104.

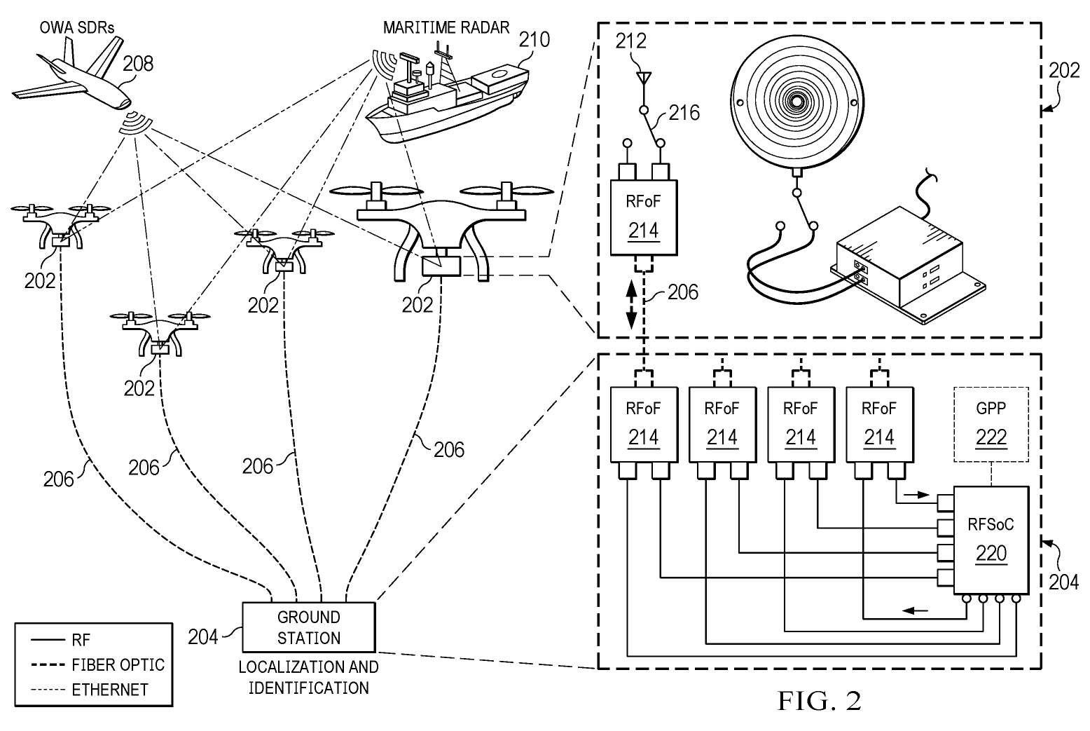

FIG. 2 illustrates a block diagram of example hardware components of a drone 202 and a ground station 204 in a system 200 in accordance with this disclosure. The system 200 may, for example, represent a specific implementation of the system 100. Thus, the drones 202 may represent the passive sensors 106 of FIG. 1, and the ground station 204 may represent the base station 108 of FIG. 1.

As shown in FIG. 2, the drones 202 may include quad copters or any other type of airborne drone capable of carrying RF receiving components. The ground station 204 provides connection to multiple drones 202, including those having passive sensor capabilities. Each of the drones 202 may be connected to the ground station 204, such as via a fiber-optic tether 206. While FIG. 2 illustrates the use of four separate drones 202, it will be appreciated that a greater or smaller number of drones 202 may be utilized. The drones 202 may be used to passively detect active targets, such as one-way attack (OWA) software-defined radios (SDRs) 208 or maritime radars 210. Of course, it will be appreciated that any RF-emitting target can be detected by the passive array of drones 202.

In this example, each of the drones 202 includes an antenna 212 that is in connection with an RF-over-fiber converter 214 through a switch 216. The antenna 212 receives active RF signals, such as from the targets 208-210, and provides the received RF signals through the switch 216 to the RF-over-fiber converter 214. The switch 216 enables switching between a transmit side and a receive side of the RF-over-fiber converter 214. In a receive mode, the RF-over-fiber converter 214 receives RF signals from the antenna 212 and converts the RF signals into optical signals for transmission over a fiber-optic cable 218. In a transmit mode, the RF-over-fiber converter 214 converts optical signals received over the fiber-optic cable 218 into RF signals for transmission from the antenna 212. In some cases, the switch 216 may be connected to the transmit side of the RF-over-fiber converter 214.

The optical signals from the drones 202 are received over the fiber-optic cables 218 at the ground station 204. The ground station 204 includes a plurality of RF-over-fiber converters 214 that are each connected to a fiber-optic tether 206 that enables the reception of optical signals from one of the drones 202. In a manner similar to that described previously, received optical signals from the drones 202 may be converted from optical signals back to recovered RF signals and provided to a radio frequency system-on-a-chip (RFSoC) 220. The RFSoC 220 processes the received RF signals and determines time differences of arrival (TDOAs) of the RF signals received at the drones 202 connected to the ground station 204. In alternative embodiments the signals may be passed from the RFoF converters 214 to the RFSoC 220, through the RFSoC to a central processing unit, or directly to a central processing unit for TDOA/signal localization. The processing by the RFSoC 220 can involve performing cross-correlation of the time differences of arrival, which can be enhanced by wideband digital sampling that provides for coherent gain and precision time difference detection and self-calibrating fiber-optic transport over the fiber-optic tethers 206 (which only provides residual systematic timing errors). Based upon this, the RFSoC 220 can determine the positions of the targets 208-210 that are detected by the antennas 212 of the drones 202. At least one processor 222 may provide control signals for the RFSoC 220 or perform other functions (possibly including the functions of the RFSoC 220 described above).

Although FIGS. 1 and 2 illustrates examples of systems 100 and 200 for passive detection and tracking, various changes may be made to FIGS. 1 and 2. For example, various components in each of FIGS. 1 and 2 may be combined, further subdivided, replicated, omitted, or rearranged and additional components may be added according to particular needs. Also, the functions of the various components used in each of FIGS. 1 and 2 may be implemented in any suitable manner.

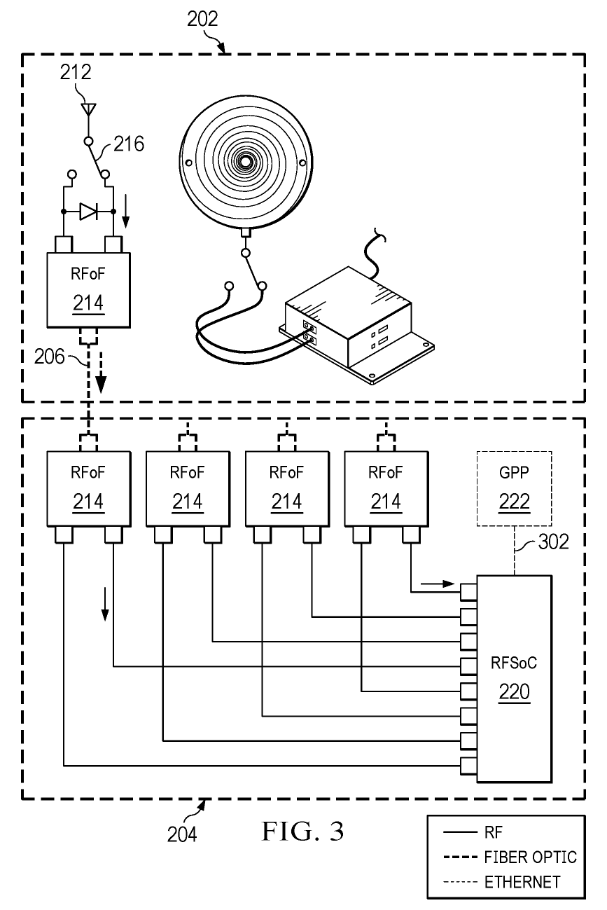

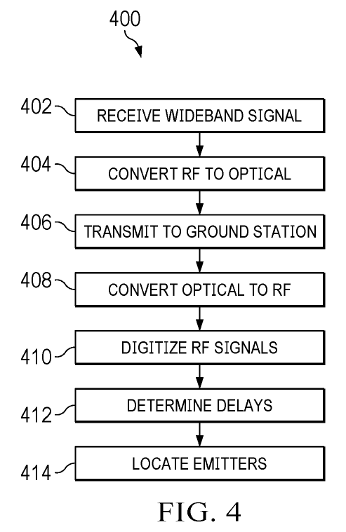

FIG. 3 illustrates a block diagram of example components used for determining an emitter location in accordance with this disclosure, and FIG. 4 illustrates a flow diagram of an example process 400 for determining an emitter location using the components of FIG. 3 in accordance with this disclosure. In some cases, for example, the components of FIG. 3 may be implemented in the base station 108 or ground station 204 and in the passive sensors 106 or drones 202.

While FIG. 3 illustrates only a single drone 202 transmitting signals to the ground station 204 over a fiber-optic tether 206, it will be appreciated that each of the RF-over-fiber converters 214 at the ground station 204 can receive optical signals over fiber-optic tethers 206 from multiple drones 202. Thus, in the embodiment of FIG. 3, optical signals may be received from four separate drones 202. However, as discussed previously, the number of drones 202 may be greater or lesser than four to implement the process described here.

As shown here, the process 400 allows a position of a detected signal to be determined. Wideband RF signals are received at step 402, such as by using low-gain omnidirectional antennas or other antennas 212 carried on the drones 202. The received RF signals are converted to optical signals at step 404, such as by using the RF-over-fiber (RFoF) converters 214 of the drones 202. Each of the converted optical signals may carry a very wide instantaneous bandwidth. The converted optical signals are transmitted to a ground station, such as over a spooled-out fiber-optic tether 206, at step 406. The transmission from the drones 202 to the ground station 204 can introduce a fixed unknown delay in the signal transmissions. In some cases, transmissions over the fiber-optic tethers 206 can use lasers supporting wavelength division multiplexing (WDM) in order to provide full duplex communications over single fibers. The optical signals received over the fiber-optic tethers 206 are converted back into recovered RF signals, such as by using the RF-over-fiber converters 214 at the ground station 204, at step 408.

The recovered RF signals are provided to the RFSoC 220 by the RFoF converters 214. The RFSoC 220 digitizes each incoming RF signal from a separate drone 202, at step 410. The digitized signals are time tagged by using a common clock, processed, such as by using an onboard field programmable gate array (FPGA) within the RFSoC 220, that computes cross-correlation to determine delays from each of the drone receivers and reports these (such as over an Ethernet connection 302) to the processor 222 at step 412. Software within the processor 222 tracks cross-correlation delays, performs localization of RF emitter sources, and processes in-phase and quadrature (I/Q) samples to enable emitter location at step 414. In this way, a particular target associated with the RF signals received by the drones 202 may be identified. By utilizing the TDOA delay determinations using the drones 202, the process 400 enables coherent RF processing for precision geolocation of RF emitter signals.

Although FIGS. 3 and 4 illustrate examples of components and processes for determining an emitter location, various changes may be made to FIGS. 3 and 4. For example, various components in FIG. 3 may be combined, further subdivided, replicated, omitted, or rearranged and additional components may be added according to particular needs. Also, while shown as a series of steps, various steps in FIG. 4 may overlap, occur in parallel, occur in a different order, or occur any number of times (including zero times).

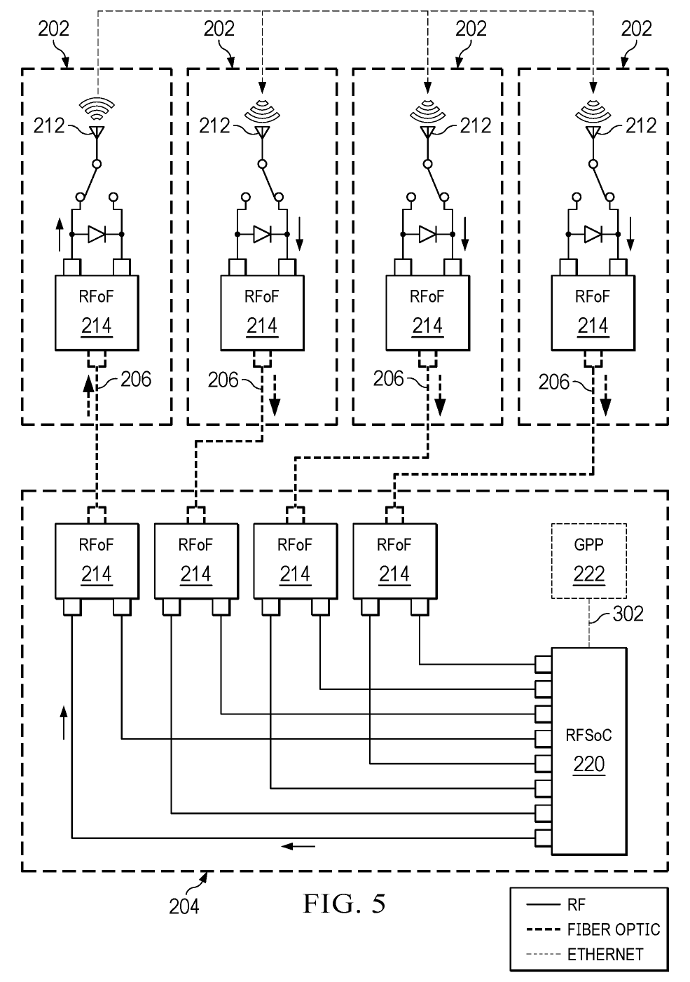

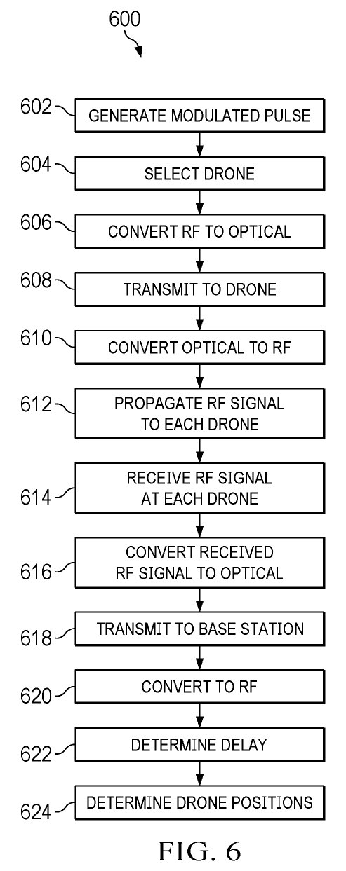

FIG. 5 illustrates a block diagram of example components used for determining locations of drones within a drone array in accordance with this disclosure, and FIG. 6 illustrates a flow diagram of an example process 600 for determining locations of drones within a drone array in accordance with this disclosure. In some cases, the process 600 can be used for self-calibrating positions of various drones 202 providing signals to a ground station 204. The ability to self-calibrate drone positions enables better estimations of the positions of RF emitters providing signals that are received by the drones 202. The ability to self-calibrate drone positions also provides the ability to alter drone positions to provide better detection capabilities and determinations of holes in the coverage area of the variable array provided by the drones 202.

As shown here, the RFSoC 220 generates a sounding signal to provide for ranging and position detection of the drones 202 at step 602. An N-way switch 504 selects one drone 202 at a time for receiving a sounding signal at step 604. In other embodiments, however, the RFSoC 220 may transmit the sounding signal directly to the RFoF converter 214 for a particular drone 202. The RFoF converter 214 receiving the sounding signal converts the sounding signal to an optical signal at step 606. The optical signal is transmitted at step 608, such as over the fiber-optic tether 206 to the selected drone 202. Upon receipt at the drone 202, the RFoF converter 214 associated with the drone 202 converts the received optical signal back to an RF sounding signal at step 610.

The received sounding signal is transmitted as an RF signal from the antenna 212 of the receiving drone 202 to enable the signal to be propagated to each of the other drones 202 at step 612. In order to propagate the sounding signal, the drone 202 receiving the sounding signal transmits the pulse from its antenna 212. The transmitted RF signal propagates line-of-sight to each of the other drones 202 within the array. The other drones 202 within the array can receive the transmitted signal at their own antennas 212 at step 614. At each of the other drones 202, the received signal is converted by the RFoF converter 214 from the received RF signal back into an optical signal at step 616. This allows the optical signals to be transmitted back to the ground station, such as over the fiber-optic tethers 206, at step 618. The receiving drone 202 need not have any knowledge of the ranging function of the received sounding signal.

The optical signal received at the ground station 204 is converted back into an RF signal by the RFoF converter 214 associated with the receiving drone and transmitted to the RFSoC 220 at step 620. The RFSoC 220 cross-correlates the received RF signal with the self-generated reference from step 602 in order to determine a delay time for one-way ranging at step 622. This information is provided to the processor 222, which calculates updates to the relative navigation state and position of the various drones 202 based upon the ranging measurement at step 624. This process can be repeated with the sounding signal being transmitted from each drone 202 and received by each of the other drones 202 in order to provide a more detailed self-calibrated positioning navigation update.

The ability to self-calibrate the positions of the drones 202 enables the continuous, periodic, or other motion of the drone array to create diverse coverage geometries, such as to overcome weak spots within a particular coverage area and smooth suboptimal geometries to better localize threat emitters. Additionally, the self-calibration process enables predictive performance rebalancing on the fly with adaptively changing drone formations. The self-calibration process additionally enables the drones 202 to accurately position themselves, allowing the drones 202 to operate with low-cost Global Positioning System (GPS), inertial navigation system (INS), or other instrumentation and in the presence of extreme GPS denial or other countermeasures.

Although FIGS. 5 and 6 illustrate examples of components and processes for determining locations of drones within a drone array, various changes may be made to FIGS. 5 and 6. For example, various components in FIG. 5 may be combined, further subdivided, replicated, omitted, or rearranged and additional components may be added according to particular needs. Also, while shown as a series of steps, various steps in FIG. 6 may overlap, occur in parallel, occur in a different order, or occur any number of times (including zero times).

In some embodiments, various functions described in this patent document are implemented or supported by a computer program or other program that is formed from computer readable program code or instructions and that is embodied in a computer or machine readable medium. The phrases “computer readable program code” and “instructions” include any type of code, including source code, object code, and executable code. The phrases “computer readable medium” and “machine readable medium” include any type of medium capable of being accessed by a computer or other machine, such as read only memory (ROM), random access memory (RAM), a hard disk drive (HDD), a compact disc (CD), a digital video disc (DVD), or any other type of memory. A “non-transitory” computer or machine readable medium excludes wired, wireless, optical, or other communication links that transport transitory electrical or other signals. A non-transitory computer or machine readable medium includes media where data can be permanently stored and media where data can be stored and later overwritten, such as a rewritable optical disc or an erasable storage device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present application should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A system for passive detection of radio frequency (RF) signals comprising:
a plurality of inputs configured to receive a plurality of signals associated with received RF signals; and
a base station configured to receive the plurality of signals, determine cross-correlation delays between pairs of the plurality of signals, and determine a position of a source of the received RF signals based on the determined cross-correlation delays.

2. The system of claim 1, wherein the base station comprises:
converter circuitry configured to convert the received plurality of signals into recovered RF signals; and
at least one processor configured to determine the position of the source based on receive delays calculated from a cross-correlation of the recovered RF signals.

3. The system of claim 1, wherein the base station comprises:
converter circuitry configured to convert the received plurality of signals into recovered RF signals;
RF processing circuitry configured to determine the receive delays calculated from cross-correlation of the recovered RF signals; and
at least one processor configured to determine the position of the source.

4. The system of claim 1, further comprising:
a plurality of receivers configured to receive the RF signals and convert the received RF signals into the plurality of signals for transmission to the base station; and
a plurality of fiber optic tethers configured to connect the plurality of receivers to the base station.

5. The system of claim 4, wherein the base station is configured to:
transmit a sounding signal;
receive a plurality of RF response signals based on the sounding signal from the plurality of receivers; and
determine positions of the plurality of receivers based on the plurality of RF response signals.

6. The system of claim 4, wherein each receiver comprises:
an antenna configured to receive the RF signals; and
converter circuitry configured to convert between RF signals and optical signals.

7. The system of claim 4, wherein receivers are configured to be repeatedly repositioned to alter a coverage area provided by the plurality of receivers.

8. The system of claim 1, wherein the base station is configured to determine the cross-correlation delays using cross-correlation of time differences of arrival between the pairs of the plurality of signals.

9. A method for passive detection of radio frequency (RF) signals comprising:
receiving a plurality of signals associated with received RF signals from a plurality of receivers at a base station;
determining cross-correlation delays between the plurality of signals; and
determining a position of a source of the received RF signals based on the determined cross-correlation delays.

10. The method of claim 9, further comprising:
converting the received plurality of signals into recovered RF signals using converter circuitry at the base station; and
determining the cross-correlation delays and determine the position of the source based on the recovered RF signals using at least one processor at the base station.

11. The method of claim 9, further comprising:
converting the received plurality of signals into recovered RF signals using converter circuitry at the base station;
determining the cross-correlation delays using RF processing circuitry at the base station; and
determining the position of the source of the received RF signals based on the determined cross-correction delays using at least one processor at the base station.

12. The method of claim 9, further comprising:
receiving the RF signals at the plurality of receivers;
converting the received RF signals into the plurality of signals for transmission to the base station; and
transmitting the plurality of signals over a plurality of fiber optic tethers connecting the plurality of receivers to the base station.

13. The method of claim 9, further comprising:
transmitting a sounding signal from the base station to the plurality of receivers;
receiving a plurality of RF response signals based on the sounding signal from the plurality of receivers at the base station; and
determining positions of the plurality of receivers based on the plurality of RF response signals at the base station.

14. The method of claim 9, further comprising:
repeatedly repositioning the plurality of receivers to alter a coverage area provided by the plurality of receivers.

15. The method of claim 9, wherein determining the cross-correlation delays comprises using cross-correlation of time differences of arrival between the pairs of the plurality of signals at the base station.

16. A system for passive detection of radio frequency (RF) signals comprising:
a plurality of receivers configured to receive the RF signals and convert the received RF signals into a plurality of signals;
a base station configured to:
receive the plurality of signals;
determine cross-correlation delays between pairs of the plurality of signals;
determine a position of a source of the received RF signals based on the determined cross-correlation delays;
transmit a sounding signal from the base station;
receive a plurality of RF response signals based on the sounding signal from the plurality of receivers; and
determine positions of the plurality of receivers based on the plurality of RF response signals; and
a plurality of fiber optic tethers configured to connect the plurality of receivers to the base station.

17. The system of claim 16, wherein the base station comprises:
converter circuitry configured to convert between optical signals and RF signals;
RF processing circuitry configured to determine the cross-correlation delays; and
at least one processor configured to determine the position of the source.

18. The system of claim 17, wherein the converter circuitry comprises a plurality of RF-over-fiber converters, each RF-over-fiber converter of the plurality of RF-over-fiber converters associated with one of the plurality of receivers.

19. The system of claim 16, wherein each receiver comprises:
an antenna configured to receive the RF signals; and
converter circuitry configured to convert between RF signals and optical signals.

20. The system of claim 16, wherein receivers are configured to be repeatedly repositioned to alter a coverage area provided by the plurality of receivers.
